(19) United States
(12) Patent Application Publication
(10) Pub. No.: US 2010/0305875 A1
(43) Pub. Date: Dec. 2, 2010

(54) PIPELINE IN-LINE INSPECTION SYSTEM

(75) Inventors: Bobby Don WILLIAMS, Katy, TX (US); Danny Lee Williams, Katy, TX (US); Vikraman Thiri Raghavan, Katy, TX (US)

Correspondence Address: KRUEGER ISELIN LLP (SC), P O BOX 1906, CYPRESS, TX, 77410-1906, US

(73) Assignee: EnviroCal, Inc., Katy, TX (US)

(21) Appl. No.: 12/790,839

(22) Filed: May 30, 2010

Related U.S. Application Data
(60) Provisional application No. 61/182,959, filed on Jun. 1, 2009.

(51) Int. Cl. G01B 5/28

(52) U.S. Cl. 702/35

(57) ABSTRACT

Disclosed herein is an in-line inspection system for providing recorded measurements of internal deviations of pipeline walls. It is particularly adapted for use with pipelines carrying gas or liquid (fluids) to diagnose pipeline defects including partial obstructions by dents, out-of-round portions, or valves which reduce the available cross section and carrying capacity of the line as well as restrict the insertion of other in-line inspection technologies. Moreover, certain embodiments are light, maneuverable, and designed to be useable by any individual to obtain immediate results. Such embodiments offer new business models for providing inspection services and should result in sharply reduced inspection costs.

### CROSS-REFERENCE TO RELATED APPLICATIONS

The present application claims priority to Provisional U.S. App. No. 61/182,959, titled “Pipeline In-Line Inspection System” and filed Jun. 1, 2009 by Bobby Williams, Danny Williams, and Vikraman Raghavan. The referenced application is hereby incorporated herein by reference.

### BACKGROUND

The present disclosure pertains to the field of liquid and gas pipelines, specifically in the technical field of internal pipeline inspection.

Pipeline in-line inspection tools, known as pigs, are used for detecting pipeline condition changes. The pig is placed in the pipeline and propelled by fluid flow from the product being transported through the pipeline. Alternatively, the pig can be tethered from a cable from outside the pipeline and transported by pulling on the cable. It is common practice to insert a pig into a pipeline and use it as an in-line inspection tool.

Pipeline defect data is collected in or on the pig as it is propelled through the pipeline. The information collected on these anomalies can be, for example, the location, size and/or shape of dents, buckles or of corrosion in the pipeline. This information is later retrieved from the pig after the pig is removed from the pipeline. The retrieved information is then analyzed and the pipeline repaired as warranted by the analyzed data.

Pipeline operators and owners have a strong interest in obtaining meaningful information about the condition of their pipeline as soon as possible after an in-line inspection event; the pipeline could be unsafe and/or could be unsuitable for passage of other in-line inspection equipment. Prior types of pigs perform a pipeline operator's primary objective to varying degrees but are plagued by substantial compromise of pipeline operator's other objectives. Pigs that provide adequate information of pipeline condition are logistically cumbersome due to physical size and complexity, require specialized skills to operate safely and effectively, and require time-consuming specialized skills to analyze the information. Pigs that provide timely information are not capable of adequate and definitive information without a very large risk of inaccuracy and uncertainty, and often require specialized skills to operate safely and effectively. Consequently, pipeline operators are forced to settle for poor information regarding their pipelines or to accept specialized labor intensive long delays of pipeline integrity discovery.

### BRIEF SUMMARY

Disclosed herein are pipeline in-line inspection systems and methods of using said inspection systems to simplify the inspection of pipelines and simplify the analysis of the inspection information, thereby reducing overall cost to the end user and allowing the user to view and apply adequate and definitive pipeline inspection results at the time of pig removal from a pipeline.

At least some of the disclosed pipeline in-line inspection systems include an in-line inspection device (pig) and a user interface module. Some system embodiments are designed to be extraordinarily light, thereby making them easier to handle and operate. These embodiments do not require the traditional use of additional manpower or lifting devices such as backhoes or forklifts, and they are considerably more resistant to damage as compared to prior pigs due to the use of energy absorbing design features.

At least some of the disclosed inspection systems are designed to be very user-friendly. Through the use of sensors and programming, the in-line inspection device detects when it is removed from the transport case and it becomes electronically energized (“powers on”) automatically. To prepare the in-line inspection device for launch, the user need only press a single button on the user interface module. Data recovery and device stowage are similarly easy to perform. Thus the design of the system precludes any need for specialized skills. In at least some embodiments the present inspection system provides a user interface module for review of adequate and definitive inspection results at the time of removing the in-line inspection device from a pipeline. Thus these embodiments eliminate all the traditional requirements for specialized field personnel and provide immediate access to definitive results.

The present disclosure will include the existence of equivalent variations of the specific embodiment, method, and examples described herein. The present disclosure should therefore not be limited by the below described embodiment, method, and examples, but by all embodiments and methods within the scope and spirit of the appended claims.

### BRIEF DESCRIPTION OF THE DRAWINGS

FIG. 1 is a side view of a novel inspection system (the in-line inspection device and the user interface module).

FIG. 2 is a front perspective view of the in-line inspection device of FIG. 1.

FIG. 3 is a section view of the in-line inspection device of FIG. 2.

FIG. 4 is a data system flow diagram of the present inspection system of FIG. 1.

FIG. 5 is a selection and display diagram of the user interface module of the present inspection system of FIG. 1.

FIG. 6 is a graphical representation of using the present inspection system of FIG. 1.

FIG. 7 is a flow diagram of a business model for use with the inspection system of FIG. 1.

### DETAILED DESCRIPTION

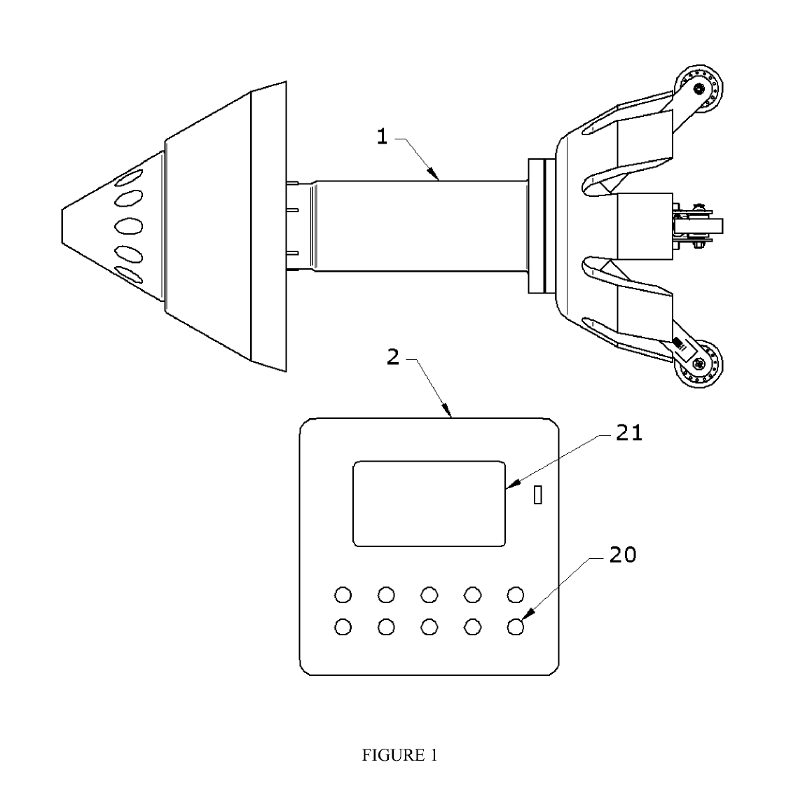

Referring now to the drawings, in FIG. 1 there is shown an illustrative embodiment of an in-line inspection device 1, and a user interface module 2. User inputs and commands are provided through a plurality of buttons 20 (or other type of control or switch) on the user interface module 2. Inspection results and other system notifications are viewed on the display 21 of the user interface module 2.

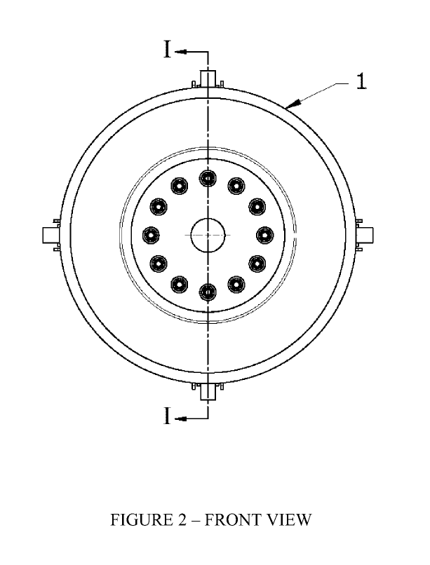

In FIG. 2 there is shown a front view of an in-line inspection device 1 of the illustrative system embodiment.

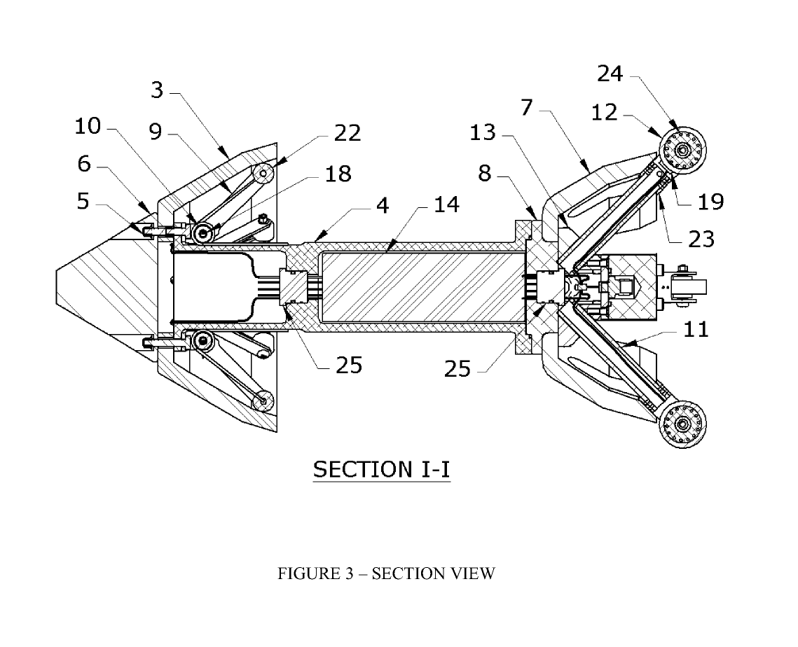

In FIG. 3 there is shown a section view of the in-line inspection device 1 having a sealing member 3 (variously referred to herein as a sealing cup, a drive cup, a sealing disk, or a drive disk) attached to the forward mounting flange of the main body 4 by fasteners 5. The sealing cup, drive cup or disk 3 is approximately 15% larger in diameter than the pipeline inside diameter and provides a seal to allow propulsion of the in-line inspection device through the pipeline as well as an interface to gather deviations of the pipe inner surface. A bumper cone 6 is also attached to the forward mounting flange of the main body 4 by the same fasteners 5.

A rear support cup or disk 7 is the same diameter as the front cup 3, and is attached to an aft closeout plate 8 with fasteners that thread into the aft face of the main body 4. In some embodiments, support cup 7 includes slots to enable pressure equalization across the support cup, thereby maximizing the drive force on sealing cup 3. The sealing cup, drive cup or disk 3 and rear support cup or disk 7 are also used for positioning the main body 4 to the centerline of the pipeline circumference. The sealing cup, drive cup or disk 3, the bumper cone 6 and the rear support cup or disk 7 can be molded from urethane or other flexible compound having compatibility with the pipeline transported media while still maintaining adequate stiffness to position the main body 4 to the centerline of the pipeline circumference. The main body 4 and the aft closeout plate 8 are machined from aluminum when pipeline media chemical compatibility permits but may also be constructed from other metallic materials as physical loads and chemical compatibility dictate.

Still referring to FIG. 3, there is shown a plurality of measurement arms 9 mounted around the circumference of the main body 4, and located on the rear side of the forward flange of the main body 4. The measurement arm 9 is a dual cantilever design rotating on a bearing assembly 10 at the pivot and having an arm pad 22 attached at the free end to move with the deflections of the front sealing cup, drive cup or disk 3.

There are at least quantity one measurement arms 9, but preferably approximately one for every inch of pipeline nominal diameter, but quantity may be increased to meet pipeline operator requirements for circumferential resolution. The measurement arms 9 are evenly spaced along the main body 4 circumference. A rotary sensor 18 is mounted inside the bearing assembly 10 at the pivot of each measurement arm 9 to detect the angular deflection of each measurement arm 9. Aluminum is a preferred material used extensively on the measurement arm 9 to reduce weight, though various lightweight metallic, non-metallic or composite materials may be used as chemical compatibility requirements with pipeline media dictate.

Still referring to FIG. 3, there is shown a plurality of distance or odometer arms 11 attached to the same quantity of brackets 13 by fastening, preferably with adhesive but could be with a conventional bolt and nut arrangement. The quantity of distance or odometer arms 11 is at least one and preferably four. The brackets 13 are attached to the main body 4 with fasteners through the support cup or disk 7 and the closeout plate 8. The length of the odometer arms 11 are determined by the distance required to extend aft of the support cup or disk 7. The odometer arms 11 are constructed from non-metallic materials having good transverse spring properties within the limitations of chemical compatibility with pipeline media. The bracket 13 is constructed from various lightweight metallic materials chemically compatible with the pipeline media.

Still referring to FIG. 3, there is shown a circular disc 12 made of various metallic and/or non metallic compounds located at the unrestricted end of each distance or odometer arm 11. The circular disc 12 is attached with and rotates on a fastener along its center axis and through a bracket 23. The circular disc 12 uses a series of magnets 24 embedded into the side of the circular disc 12 to trigger a sensor 19 inside the bracket 23 as a means to collect traveled distance during the inspection period.

Still referring to FIG. 3, there is shown an electronics package 14 located inside the main body 4 that confines the data recorder 15, data processor 16 and the power supply 26, excluding sensor 18 and sensor 19. The power supply 26 provides DC voltage to all electronics on the in-line inspection device 1. Physical transmission from the sensors 18 and sensors 19 to the electronics package 14 is through two wire bulkhead assemblies 25.

The tool configuration shown in FIGS. 1-3 is that of a unitary body or “single-section” tool. In other words, the in-line inspection device preferably does not comprise a flexible joint to provide for flexing of the tool's central spine. Such a joint would undesirably lengthen the tool, add weight, and reduce reliability.

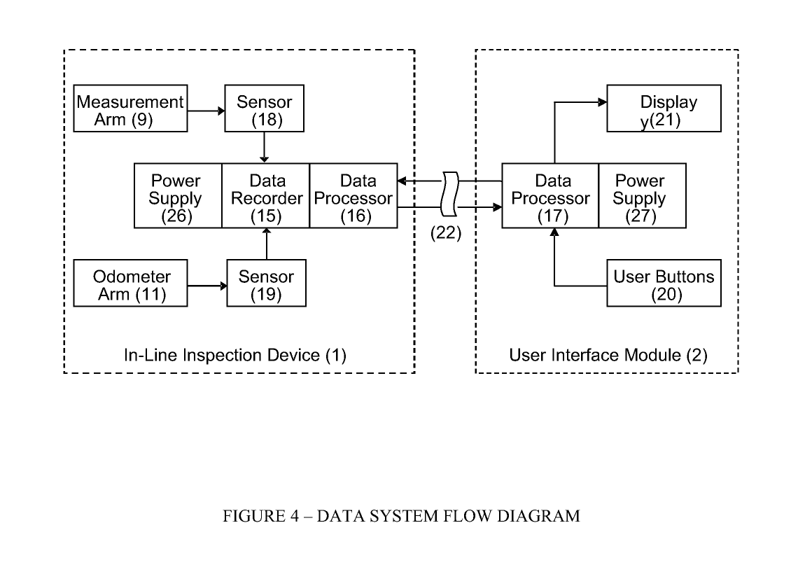

Referring now to FIG. 4, there is shown a data system flow diagram for the present inspection system in its functional perspective. The data system exists in both the in-line inspection device 1 and the user interface module 2 of the present inspection system.

In more detail, still referring to FIG. 4, the data recorder 15 records the condition of the measurement arms 9 and distance or odometer arms 11 through electrical signals received from sensors 18 and sensors 19. In some embodiments the data recorder 15 also records data from other internal sensors such as acceleration sensors, orientation sensors, temperature sensors, pressure sensors, vibration sensors, and/or radioactivity sensors. The data recorder 15 records data when propelled in a pipeline. In some embodiments, all data is recorded as a function of time, e.g., at a specified sampling rate. In other embodiments, the data is recorded as a function of distance. On request by the data processor 16 and/or data processor 17, all the recorded data is transferred to the data processor 17.

In further detail, still referring to FIG. 4, the user communicates with the data processor 17 through the user controls 20 on the user interface module 2. The user monitors results through the display 21. The user can also perform system checks and system maintenance routines through the user interface module 2. The power supply 27 provides DC voltage to all electronics in the user interface module 2.

In further detail, still referring to FIG. 4, the data system with its subcomponents, data recorder 15, data processor 16 and data processor 17 may be constructed using one or more proprietary or standard off-the-shelf hardware specifically designed and/or modified to collect and process different data types as needed for various requirements of the pipeline operator. The communication link 22 between the in-line inspection device 1 and the user interface module 2 may be through a detachable wire harness or may be through a wireless interface (e.g., an infrared or radiofrequency communications link). The in-line inspection device 1, user interface module 2 and the communication link 22 are not necessarily physically discrete systems.

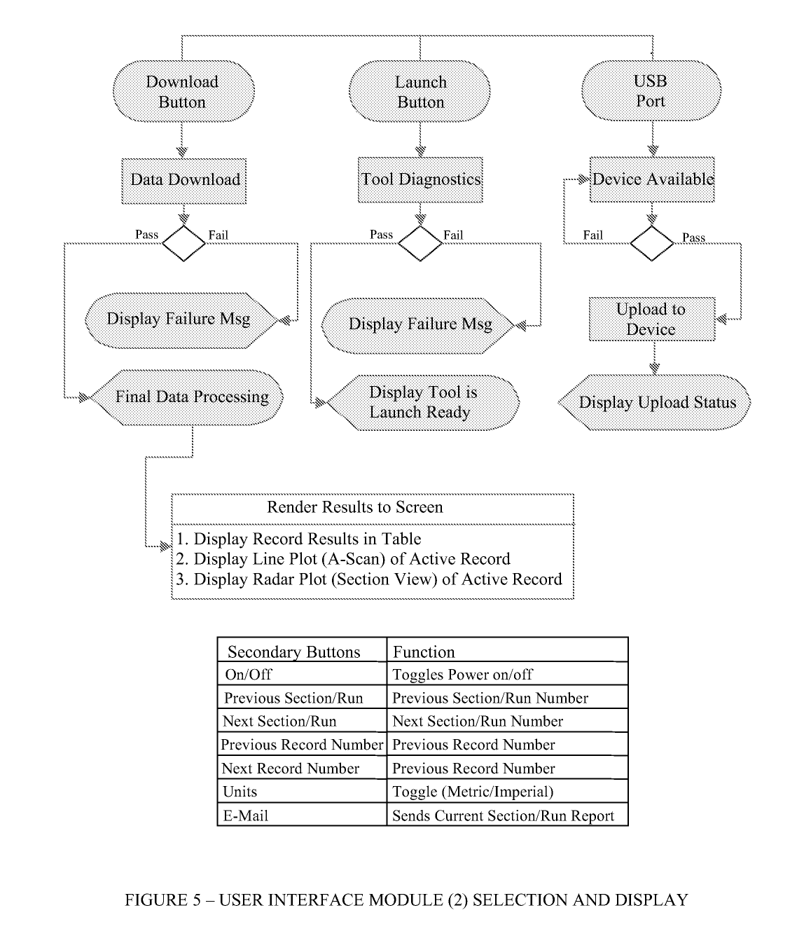

Referring now to FIG. 5, there is shown the selection and display options available on an illustrative user interface module. The user interface module monitors a built-in USB port for activity. If a device is plugged in to the USB port, the user interface module detects that the device is there and “pairs” with it. In other words, the user interface module verifies that the device is a compatible storage device and uploads the data from the in-line inspection device. If desired, other information such as software and firmware updates can similarly be sent over the USB connection. The user interface module may then attempt to communicate with the compatible storage device to test whether the pairing was successful. In any event, the user interface module displays the upload status as the upload process is carried out, and concludes with a failure code or a successful completion message.

The user interface module further includes a launch button (or other type of switch). When a user actuates the launch button (after having place the in-line inspection device in position for launch), the user interface module communicates wirelessly with the in-line inspection device, causing it to boot up, conduct a self-diagnostic test, and wirelessly report back to the user interface module. As part of the launch process, the user interface module determines a current GPS time and date and communicates it to the in-line inspection device. The user interface module reports to the user the in-line inspection device status and concludes with a failure message or a “Ready-to-Launch” message. Upon receiving a ready-to-launch message, the user is expected to send the in-line inspection device on its way, e.g., by closing up the pipe and restoring fluid flow along the pipe.

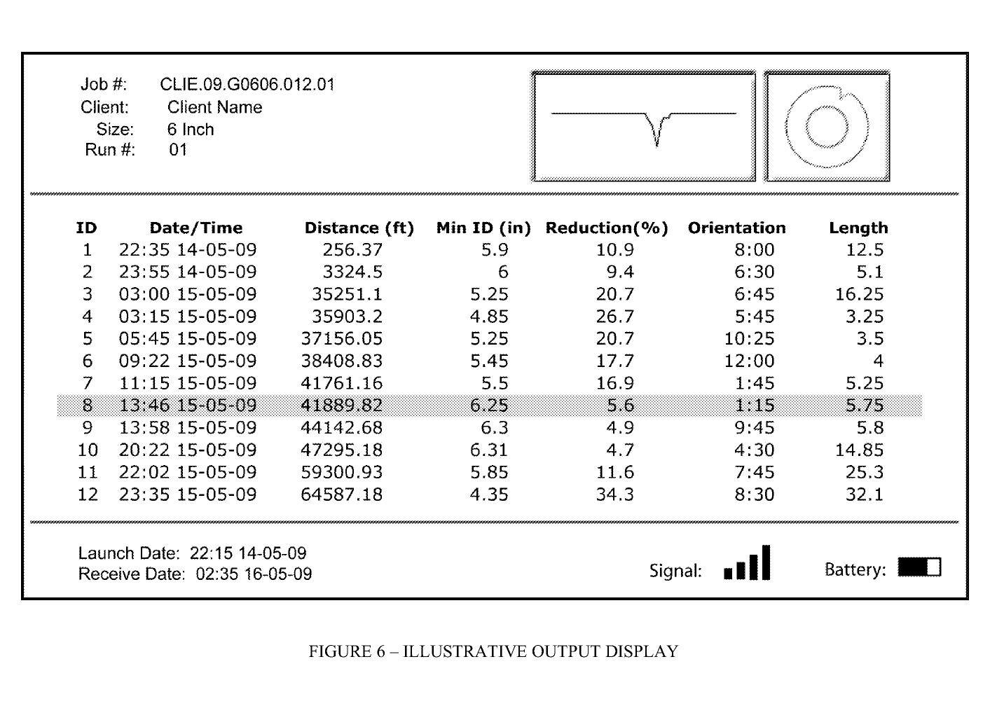

The user interface module also includes a download button or control. Having retrieved the in-line inspection device from a pipe and having positioned the user interface module within range, the user actuates the download button to retrieve data from the in-line inspection device. A failure message is displayed if the download is unsuccessful. Otherwise, the user interface module begins processing the downloaded data and generates a result screen for the current run of the in-line inspection device (see, e.g., FIG. 6). The result screen may include a table of information about “events” detected by the in-line inspection device. As particular events are selected, the user interface module may display a graphical profile of the event in the form of a line plot and/or a radar plot.

The user interface module can of course include additional buttons or other control mechanisms for navigating between events and navigating between runs. A unit button may toggle between metric and imperial units. An email button can be provided to have the current run report emailed to a predetermined email address. A power button can be provided to turn the device on and off. Any or all of these buttons can be implemented as areas on a touch-sensitive screen. In some embodiments a keyboard is provided to allow the user to provide input in text format.

FIG. 6 shows an illustrative results screen to demonstrate the ease of using certain embodiments of the disclosed system. The top portion of the screen includes information about the client, the job number, the pipe size, and the run number. The run number increments automatically, but the other values can be preprogrammed into the user interface module or entered in the field. Also along the top of the screen is a line plot and a radar plot. The line plot shows the internal profile of a selected event along the line of travel of the in-line inspection device. The radar profile shows the internal profile of the selected event around the circumference of the pipe. For easier visibility, the scale may be magnified so that, e.g., the internal circle in the radar plot represent a 10% diameter reduction.

The middle portion of the screen includes a list of events and their corresponding information. Because most of the pipe interior is expected to be constant, it is generally unnecessary to display the interior profile for every inch of the distance between the launch point and the retrieval point. To the contrary, only those portions of the pipe that exhibit different or unexpected characteristics are of interest to most users. Consequently, the user interface module screens out the portions of the data that represent open, circular interior profiles in the expected range of diameters. The remaining portions are itemized as events.

The leftmost column specifies the event number. The second column specifies the time at which the event was observed by the in-line inspection device. The third column specifies the event's distance from the launch point. The fourth column specifies the minimum inside diameter (ID) of the pipe in that region. The fifth column simply expresses the fourth column as a percent reduction of a nominal diameter (in some cases, the outside diameter “OD” is used for this calculation). The sixth column specifies a circumferential position of the event in terms of the corresponding position of an hour hand on a clock face. The last column specifies the length of the event.

The bottom portion of the results screen provides summary information such as the start and stop times of the run, the total number of events, the amount of available memory, the wireless signal strength, and the remaining battery life. These examples are merely illustrative and not limiting.

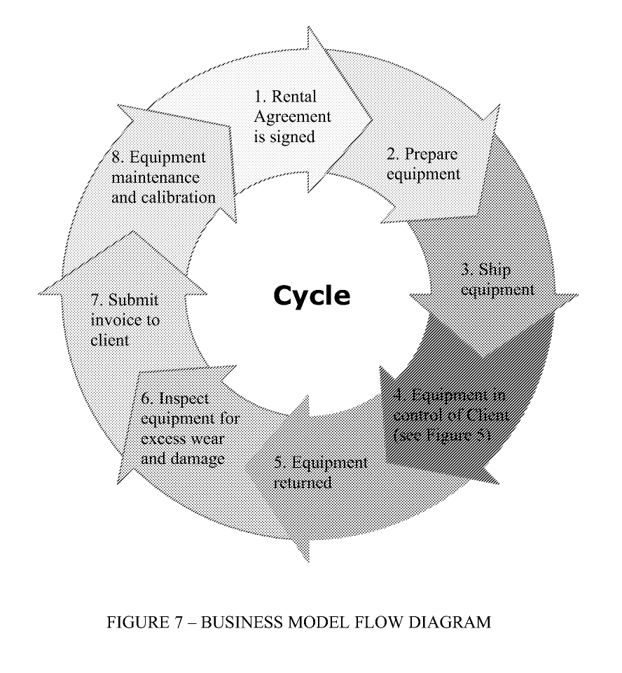

Referring now to FIG. 7, there is shown the business model activities associated with certain embodiments of the disclosed systems. At least some of the in-line inspection device embodiments are designed to be light and easily maneuverable by a single person. Moreover, the user interface module is very intuitive and user friendly, enabling the system to be used with little or no training. Consequently at least some embodiments are amenable to usage in a rental business. A third party wishing to utilize the present inspection system, typically a pipeline operator initiates a rental agreement to use an inspection system. The owners of the inspection system prepare and setup the present inspection system as needed for any special client requirements. Such preparation may include selecting an in-line inspection device having the proper dimensions and constructed from the appropriate materials for use in the environment specified in the rental agreement. The owners may further make sure the device and user module are fully charged and may further preprogram appropriate default information into the user interface module.

The inspection system is packaged in a standard shipping container and transported by standard shipping methods with no restrictions or special handling needed. The client receives the shipment and may immediately utilize the present inspection system as previously described. For example, the in-line inspection device may automatically power up upon being removed from the transport case, detecting such unpacking through built-in sensors and/or programming. (In one embodiment, the cradle for the device has carefully placed magnets that open Hall-effect switches in the device. When the device is separated from the cradle, the switches close, thereby providing power to the device.) A single button press on the user interface module verifies the inspection device firmware and prepares the device memory for storing data. Once the in-line inspection device has traveled through the pipeline and been recovered, a single button press on the user interface module suffices to retrieve the measurement data from the in-line inspection device, and the device powers down automatically when stowed. The client returns the inspection system using the original shipping container transported by standard shipping methods with no restrictions or special handling required. The owners of the inspection system perform a receiving inspection for excess wear and damage. The owners of the inspection system notify the client of required fees per the applicable rental agreement. The inspection system receives maintenance, inspections, testing and calibrations as needed based on service experience. The inspection system is then ready to repeat the above cycle. Note that at least some of the steps in this model can be performed concurrently or in a different order.

At least some embodiments of the disclosed inspection system may offer defensible inspection results (i.e., fully logged data streams at and around each of the detected events), result reports on-site within a few minutes of device retrieval, operation simplicity, and a weight that is light enough to make inspection logistics as simple as possible.

The weight of the illustrative in-line inspection device embodiments described above is expected to be about 12 lbs for a nominal 6″ device, about 25 lbs for a nominal 12″ device, and about 100 lbs for a nominal 36″ device. As a rough rule of thumb, the weight of the in-line inspection device is expected to be less than 4 lbs per nominal inch of device diameter, and in some cases can be less than 2 lbs per nominal inch of device diameter. (Note: in-line inspection devices can typically operate over a range of nominal pipe diameters. As used herein, “nominal device diameter” refers to the smallest nominal pipe diameter for which the device is specified to operate.)

As an illustration of operation simplicity, we observe that at least some embodiments of the system can include an instruction card or booklet which will be sufficient to educate first-time users on the correct and safe operation of the pipeline inspection system. Such embodiments will certainly not require consultation with experts or special training classes.

Although specific embodiments have been described hereinabove, it is recognized that one of ordinary skill in the art will understand the foregoing disclosure to include various modifications and alternative embodiments. For example, though the description focuses on a user interface having buttons for various functions, other forms of control are contemplated including rocker switches, toggles, pressure-sensitive areas on a programmable display, voice control, pointing devices, and those other mechanisms known in the art for interacting with electronic devices. It is intended that the following claims encompass such modifications and alternatives within their scope.

What is claimed is:

1. An in-line inspection device that comprises:
a single tool body having a forward end and a back end;
a flexible sealing member attached to the forward end of the tool body;
a plurality of measuring arms that contact an inner surface of the sealing member to measure interior dimensions of a pipe through which the device passes;
a support cup or disk attached to the back end of the tool body;
at least one odometer sensor; and
a processor configured to record interior dimension measurements and associated odometer measurements.

2. The device of claim 1, wherein the support cup or disk includes slots that prevent a pressure differential from developing across the support cup or disk.

3. The device of claim 1, wherein the device weighs less than 4 lbs per inch of a nominal device diameter.

4. The device of claim 1, further comprising a wireless interface that communicates recorded data from the processor directly to a user interface module that displays events represented by the data.

5. A pipeline inspection system that comprises:
an in-line inspection device that records interior dimensions of a pipeline as a function of time or distance while passing through said pipeline; and
a user interface module that retrieves recorded data from the in-line inspection device and displays a summary of events detected by the in-line inspection device.

6. The system of claim 5, wherein the user interface module is a portable device that establishes a direct communications link with the in-line inspection device to download the recorded data in response to a user action.

7. The system of claim 6, wherein the direct communications link is a wireless communications link.

8. The system of claim 5, wherein the summary of events is displayed in list form.

9. The system of claim 8, wherein the summary includes a graphical profile for a selected event.

10. A user interface module that comprises:
a user interface having:
a launch control that causes an in-line inspection device to prepare for launch, and
a download control that causes the in-line inspection device to communicate recorded data to the user interface module; and
a processor that analyzes data retrieved from the in-line inspection device and displays a data summary for user review.

11. The module of claim 10, wherein the data summary includes a list of events, each event having at least a minimum inner dimension and a position along the pipeline.

12. The module of claim 10, wherein the processor determines an axial and a circumferential profile for each event, said profiles being displayed when a user selects a corresponding event.

13. A pipeline inspection method that comprises:
obtaining a portable inspection system that includes a portable user interface module and an in-line inspection device that weighs less than 4 lbs per inch of a nominal pipeline diameter for which it was designed;
inserting the in-line inspection device into a pipeline;
preparing the in-line inspection device to launch with the actuation of a control on the user interface module;
retrieving the in-line inspection device after it has passed through some portion of the pipeline; and
downloading data from the in-line inspection device to the user interface module; and
reviewing a display of events detected by the in-line inspection device.

14. The method of claim 13, further comprising:
paying a rental fee for said portable inspection system.

15. The method of claim 13, wherein said portable inspection system is designed to make said inserting, preparing, retrieving, and downloading operations performable without specialized skills.

16. The method of claim 13, wherein said portable inspection system is designed to make said obtaining, inserting, and retrieving operations performable by an individual without artificial lifting equipment.

17. The method of claim 13, wherein the in-line inspection device weighs less than 1.5 lbs per inch of nominal diameter.

18. The method of claim 13, wherein said downloading includes establishing a wireless link between the user interface module and the in-line inspection device.

19. A method of facilitating pipeline inspection, the method comprising:
receiving an inspection system order that specifies at least a nominal diameter of a pipeline;
assembling a package that includes:
an in-line inspection device suitable for passing through said pipeline to collect pipeline defect data; and
a portable user interface module that downloads and displays recorded data from the in-line inspection device; and
providing the package.

20. The method of claim 19, further comprising:
receiving a rental fee for said package.

21. The method of claim 19, wherein the in-line inspection device weighs less than 4 lbs per inch of nominal device diameter.
